(19) United States
(12) Patent Application Publication
(10) Pub. No.: US 2017/0134500 A1
(43) Pub. Date: May 11, 2017

(54) SYSTEM AND METHOD FOR CREATING OPERATING SYSTEMS TO NETWORK PHYSICAL OBJECTS OR THINGS

(71) Applicant: AdMobilize LLC., Miami Beach, FL (US)

(72) Inventors: Rodolfo Saccoman, Miami Beach, FL (US); Brian Sanchez, Miami, FL (US)

(21) Appl. No.: 15/344,514

(22) Filed: Nov. 6, 2016

Related U.S. Application Data
(60) Provisional application No. 62/252,844, filed on Nov. 9, 2015.

(51) Int. Cl. H04L 29/08; H04L 12/24

(52) U.S. Cl. CPC H04L 67/125; H04L 67/10; H04L 67/34; H04L 41/0806

(57) ABSTRACT

System for enabling the system agnostic operation of at least one functional device, comprising a first computing device communicating with functional devices for operating the devices, cloud based infrastructure, in communication with the first computing device, for storing one or more applications for operating functional devices, the applications having a common format, the first computing device sending a command to the cloud based infrastructure to transmit information about at least one application to a second computing device, the second computing device receiving the information from the cloud based infrastructure, and determining, as a function of the information, the type of device to be operated upon and whether the second computing device can operate the device with the application.

### CROSS REFERENCE TO RELATED APPLICATIONS

This application is related to and claims priority from U.S. Provisional Patent Application No. 62/252,844 having the same title and filed Nov. 9, 2015, which is incorporated herein by reference in its entirety.

### FIELD

Exemplary embodiments disclosed herein are directed to structures and operating systems (“OS”) for developing and utilizing software applications, more specifically software applications that enable objects and things to collect data and exchange data among themselves.

### BACKGROUND

The concept of networks is decades old, evolving to a current state in which objects or things are embedded with electronics, software, sensors and network connectivity capabilities to enable the objects or things to collect and exchange data among themselves, “machine to machine”. This has become the “Internet of Things” or “IoT”. Hereafter in this description, “object” is used generically to also refer to “thing”.

It is known that the IoT allows objects to be sensed and controlled remotely across an existing network infrastructure, for more direct integration between the physical world and computer-based systems. IoT devices serve as bridge between physical and digital worlds. It is possible to use and purchase existing applications to operate devices across the IoT. The size and variety of objects to communicate with and to receive communications from the IoT are quite large and quite varied. Therefore, existing applications that enable communication between objects are closed-universe solutions based on device-specific communication protocols and operating systems. Consequently, devices are able to communicate or interact only with like devices.

For example, Apple Corp., utilizing its proprietary IOS system, and GOOGLE Corp., utilizing its proprietary Android system, have developed operating systems to enable devices to communicate or interact with each other. However, these operating systems do not have a scalable infrastructure, requiring that users build on existing application programming interfaces (APIs). Therefore, it is still required for network developers to build the connector layer between the device and the IoT infrastructure. This places the ability to create an IoT for existing devices well beyond the capabilities of even users with an advanced computer background.

As a result, the IoT has broken into two distinct groups. A first group includes communication products for device manufacturers or makers. However, such a device manufacturer or maker needs to be sophisticated in computer networking to use these products in building new applications. This is not much better than requiring a user or a device manufacturer to create his/her own connector layer, if not more. A second group includes IoT products for users. However these products are of a “plug and play” nature. They are very fixed in structure and operation. They represent a closed-universe solution which is not dynamic.

Therefore, such “plug and play” products cannot adapt or be adapted to uses and functions for which they were not initially designed.

Accordingly, a hardware (HW)/software (SW) platform that connects and enables developers and consumers to design, build and deploy applications and solutions for the physical world which overcome the shortcomings of the prior art is desired.

### SUMMARY

Exemplary system embodiments disclosed herein enable agnostic operation of functional devices. An exemplary system includes a first computing device communicating with functional devices for operating the devices. A cloud based infrastructure, in communication with the first computing device, stores one or more applications for operating functional devices. The applications have a common format, the common format being device and system agnostic. The first computing device sends a command to the cloud based infrastructure to transmit information about at least one application to a second computing device. The second computing device receives the information from the cloud based infrastructure, and determines, as a function of the information, the type of device to be operated upon and whether the second computing device can operate the device with the application.

In an exemplary embodiment, there is provided a system for enabling the system agnostic operation of a plurality of functional devices, comprising: a cloud based infrastructure for storing a plurality of applications for operating at least one of the plurality of functional devices, the applications having a common format, the common format being device and system agnostic; a first computing device; and a second computing device in communication with the plurality of functional devices, wherein the first computing device is configurable to send a command to the cloud based infrastructure to transmit information about a given application to the second computing device, and wherein the second computing device is configurable to receive the information about the given application from the cloud based infrastructure, and to determine, based on the received information, a type of a functional device that can be operated upon with the given application.

In an exemplary embodiment, the second computing device is further configurable to determine whether the second computing device can operate the functional device determined to be of a type that can be operated upon with the given application.

In an exemplary embodiment, the second computing device is further configurable to operate a functional device determined to be of a type that can be operated upon with the given application.

In an exemplary embodiment, the second computing device is controlled by an operating system (OS) and wherein the common application format includes an application format recognized by the OS to be device agnostic.

In an exemplary embodiment, the second computing device is configured to communicate with an application through the OS.

In an exemplary embodiment, a functional device that can be operated upon with the given application includes an IoT device.

In an exemplary embodiment, a functional device that can be operated upon with the given application is selected from the group consisting of a temperature sensor, a camera, an environmental controller, an HVAC controller, a light-emitting diode, a motion sensor and a motion detector.

In an exemplary embodiment, the second computing device is a portable electronic device.

In an exemplary embodiment, there is provided a method for the operation of two or more functional devices comprising the steps of: storing in a cloud infrastructure one or more applications for operating functional devices; placing all applications stored in the cloud infrastructure in a common format the common format being device and system agnostic; transmitting information identifying at least one of the stored applications to a computing device that operates at least one functional device using applications; and determining, as a function of the format of the transmitted at least one application, the type of functional device to be operated utilizing the transmitted at least one application and determining whether the computing device can operate the determined device to be operated utilizing the transmitted at least one application.

In an exemplary embodiment, there is provided a computing device having computer readable instructions stored thereon, the computer readable instructions defining an operating system executable by the computing device, the computer executable instructions, when executed cause the computing device to perform the steps of: storing in a cloud infrastructure one or more applications for operating functional devices; placing all applications stored in the cloud infrastructure in a common format the common format being device and system agnostic; transmitting information identifying at least one of the stored applications to a computing device that operates at least one functional device using applications; and determining, as a function of the format of the transmitted at least one application, the type of functional device to be operated utilizing the transmitted at least one application and determining whether the computing device can operate the determined device to be operated utilizing the transmitted at least one application.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein, and should not be considered limiting in any way. Like elements in different drawings may be indicated by like numerals:

FIG. 1 is a schematic drawing of a system constructed in accordance with an exemplary embodiment disclosed herein;

FIG. 2 is a flow chart for installing an application on a device for controlling two or more devices in accordance with an exemplary embodiment disclosed herein;

FIG. 3 is a format for the construction of an application to be utilized in accordance with an exemplary embodiment disclosed herein;

FIG. 4 is a flow chart for downloading an application from a known source to be operated upon by an OS associated with a user device in accordance with an exemplary embodiment disclosed herein;

FIG. 5 is a flow chart for downloading an application from an unknown source to be operated upon by an OS associated with user device in accordance with an exemplary embodiment disclosed herein;

FIG. 6 is an operational diagram of exchanging data between two devices which are not externally accessible in accordance with an exemplary embodiment disclosed herein;

FIG. 7 is an operational diagram of applications communicating with an OS in accordance with an exemplary embodiment disclosed herein; and

FIG. 8 is an operational diagram of the OS enabling applications to communicate with each other across the system amongst devices, in according with an exemplary embodiment disclosed herein.

### DETAILED DESCRIPTION

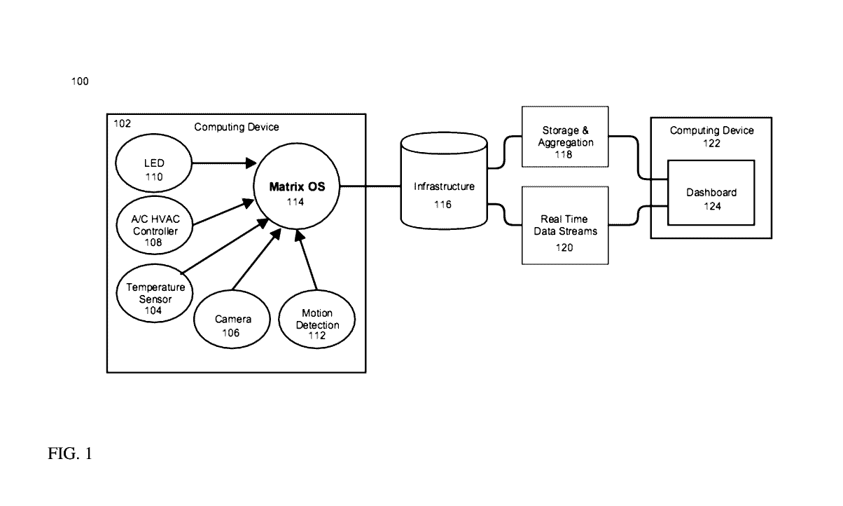

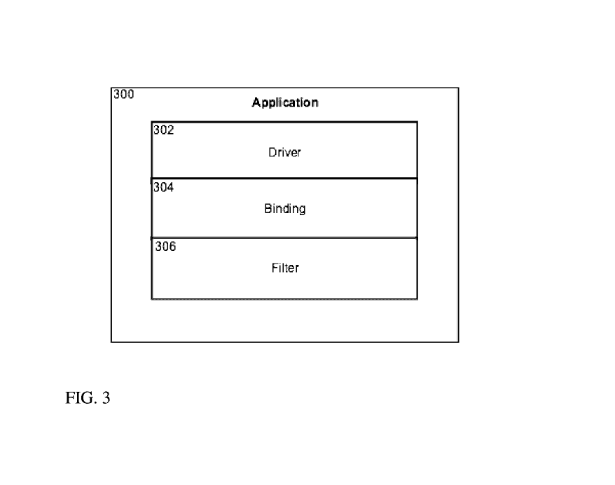

Reference is made to FIG. 1, which shows a schematic diagram of a system 100 operating in accordance with an exemplary embodiment disclosed herein. System 100 comprises a local computing device 102 controlled by an operating system (referred to herein as “Matrix OS”) 114. Matrix OS 114 comprises program code to provide functionality to computing device 102 as described below. Computing device 102 may be any device capable of processing and exchanging information with at least one device and capable of processing information exchanged between two or more devices. The devices, being devices that perform different functions or operations, may also be referred to as functional devices or operating devices. Exemplarily, computing device 102 may be a tablet, a phone, a laptop, a personal computer (PC), etc. Computing device 102 is product/application agnostic because it can process any application or device driven by an application in the format of application 300 shown in FIG. 3. The meaning of “agnostic” will become clear for the following description. By way of example, computing device 102 may communicate with functional devices such as a temperature sensor 104, a camera 106, environmental controllers such as an A/C HVAC controller 108, a light-emitting diode (LED) 110 and a motion sensor or detector 112. Computing device 102 may receive information from temperature sensor 104, motion detector 112 and camera 106 and may control the operation of camera 106, HVAC controller 108 and LED 110. In an exemplary embodiment, temperature sensor 104 may also be a conventional thermostat that monitors temperature and communicates with HVAC controller 108 through computing device 102, for controlling heating and air conditioning to adjust the temperature in an environment.

Computing device 102 may communicate with a cloud infrastructure 116 to store and aggregate in cloud infrastructure 116 data received from and/or about functional devices 106-112 and/or stored in a storage and aggregation system 118. Computing device 102 may also transmit, in real-time, data streams 120 received from sensors 102-106 and 112. The data, both real-time and aggregated, are transmitted to a user computing device 122 to be displayed at a dashboard 124 of a user device 122. User computing device 122 may, in a non-limiting embodiment, be a portable electronic device such as a tablet computer, cellular phone, smartphone, laptop and the like.

In a non-limiting embodiment, computing device 102 may communicate with cloud infrastructure 116 utilizing the Internet. Computing device 102 may also communicate with cloud infrastructure 116 across the Internet making use of conventional communication infrastructures or platforms, including land lines, Wi-Fi, cellular phone infrastructure and the like. System 100 may bypass the Internet utilizing these communication platforms to allow direct communication between computing devices 102 and 122. Computing device 102 may be hard-wired to functional devices 104-112, or may communicate with devices 104-112 remotely, utilizing the Internet, Wi-Fi, radio frequency, cellular networks or the like, so that computing device 102 may, for example, control and/or and receive information from a camera 106 positioned close-by or miles away from computing device 102.

System 100 is substantially device agnostic. One contributing factor for enabling device agnostic operation is the formatting of applications 300, see FIG. 3. The formatting enables system 100 to be device agnostic in its approach to detecting and installing applications from any source and of any type to operate devices 104-112. In other words, applications developed for the Matrix OS can run on multiple IoT hardware solutions.

Applications to be processed by computing device 102 are formatted in a manner to be recognized by Matrix OS 114 to be device and system agnostic. As shown in FIG. 3, in an exemplary non-limiting embodiment, an application 300 (to be processed by computing device 102 with or without involvement of cloud infrastructure 116) includes a driver layer 302, a binding layer 304 and a filtering layer 306. Each such application 300, when installed for a specific device, functions in the same way, regardless of the device it is installed on. Driver layer 302 is an instruction layer for driving a device in communication with, and receiving operation instructions from, computing device 102. Driver layer 302 is custom written by a party that wishes to control or receive information from a device in a particular mode of operation. Driver layer 302 may be written in a language such C++, Java, or the like. Binder layer 304 is a specific interface for a functional device such as temperature sensor 104 or camera 106. Filter layer 306 is a native (to the Matrix OS) filtering mechanism that applies event-driven triggers to the particular device to be operated upon. By way of example, for temperature sensor 104, the filter may be a schedule for reporting the temperature or a range of temperatures of interest, so that only temperatures within that range are reported. Additionally, if temperature sensor 104 is utilized to control the environment, filter layer 306 may cause Matrix OS 114 to report the sensing of a trigger temperature such as (exemplarily) 68°, to cause computing device 102 to control another device such as the HVAC controller 108 to turn on the heat to raise the temperature to another pre-determined temperature to be sensed by temperature sensor 104, to again control HVAC operation to turn of the HVAC at the desired temperature.

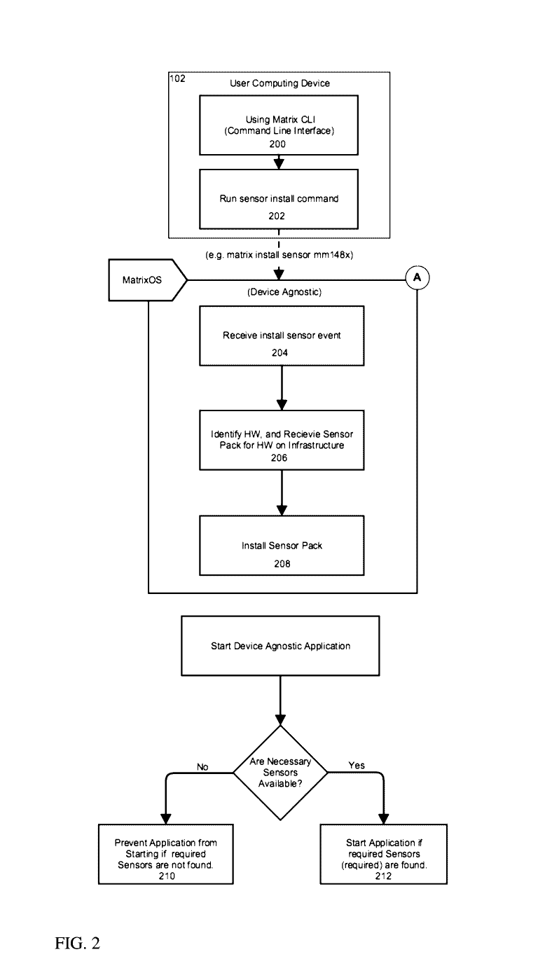

Turning now to FIG. 2, which describes schematically a method for installing an application 300 for a device to be operated upon by computing device 102. In steps 200 and 202, Matrix OS 114 receives a command from user device 122 to install an application 300, as well as a particular device (for example temperature sensor 104) associated with that application if the device has not been previously installed. Such an application may be referred to henceforth as “device application” or (in the particular case of a sensor) as “sensor application”. By way of example, Matrix OS 114 receives a command (install event) from user device 122 through cloud infrastructure 116 to install temperature sensor 104 in step 204. Because each application for a particular device is configured for its own operating system, Matrix OS 114 is able to recognize the device and/or the application OS by an operating signature (see below) in the device application in a step 206. By way of a non-limiting example, the operating signature may be considered the collection of sensors and libraries available to the application. A respective sensor pack for the device is then received. The sensor pack is exemplarily a package that includes the necessary content, driver, normalization layer, etc., including application 300 or at least an API thereto. In step 208, Matrix OS 114 installs the sensor pack. As described below, the identification of the sensor application is done by comparing known sensor application 300 configurations to the sensor application configuration to be installed. Matrix OS 114 determines whether the application 300 and/or the sensor/device are known in step 210. If known, the application is started in a step 212 and the received data is presented to a user on dashboard 124 of user device 122. If the sensor/device cannot be found in step 210, then the application will not be started and revisions are made to the sensor application in step 214.

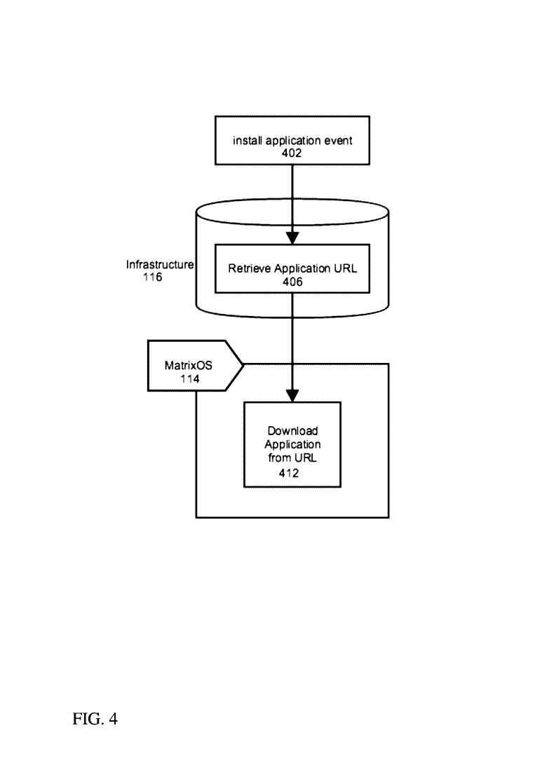

Reference is now made to FIG. 4, in which the installation of the application described in step 208 above is described in greater detail. Matrix OS 114 may access a library of known applications and devices that may be stored either locally on computing device 102, or remotely in cloud infrastructure 116. In step 402, user device 122 broadcasts a command for Matrix OS 114 (which operates on computing device 102) to install an application 300 as a third party application. In accordance with a non-limiting embodiment, in a step 406, this request is made through cloud infrastructure 116, causing cloud infrastructure 116 to retrieve a known application 300 stored in the library or in another application storage source utilizing a URL associated with third party application 300. Other identification information for pointing cloud infrastructure 116 to the source of application 300 in response to an install event may also be utilized as known in the art. The URL of the storage location for the requested application is then downloaded in a step 412 by Matrix OS 114, enabling computing device 102 to read application 300 from a database located within cloud infrastructure 116 as needed, to operate the device associated with the application. If required, application 300 may be downloaded to computing device 102.

FIG. 4 describes a methodology for downloading and utilizing an existing stored published application 300 from a third party or form a local/internal library. This is only a partial solution to the closed-universe problem. Because system 100 is application-neutral, users are also enabled to create their own applications to be loaded on computing device 102 and operated upon by Matrix OS 114.

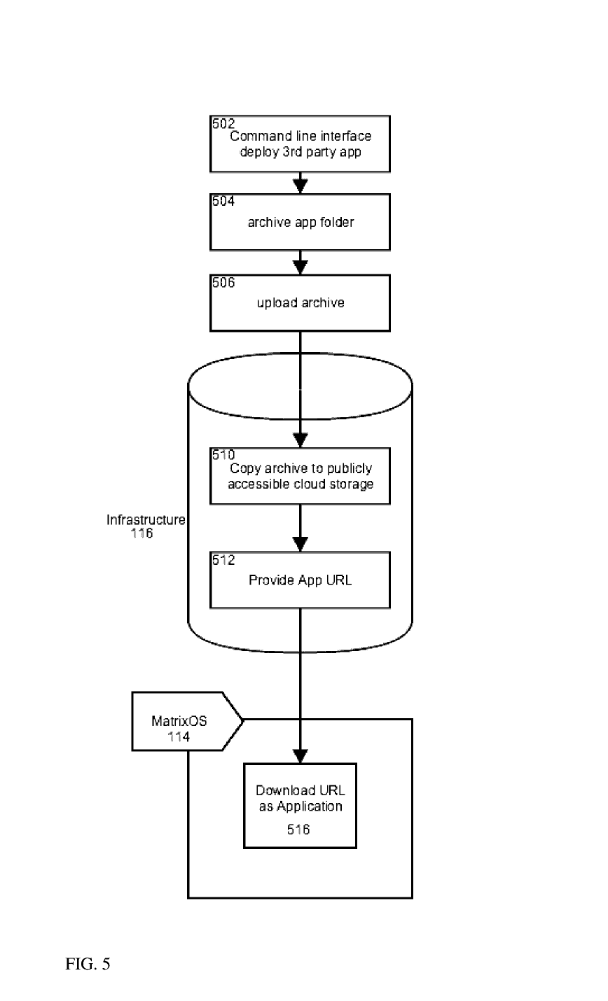

Reference is now made to FIG. 5, which describes an exemplary process for a third party application to be created and downloaded for the first time in connection with a device such as temperature sensor 104. In step 502, a third party deploys a new application 300 for temperature sensor 104, by way of example, from user device 122. In step 504, an archive application folder is created for newly created third party application 300. In step 506, the archive application folder is uploaded to an archive. In step 510, cloud infrastructure 116 copies the archive to cloud storage 118, where a URL is assigned to the respective application 300. In step 512, the respective application URL is made accessible and/or transmitted to computing device 102. In step 516, the URL (or the actual application 300) is downloaded to computing device 102 to be utilized by Matrix OS 114 as the application 300 to operate temperature sensor 104. Again,

Matrix OS 114 causes computing device 102 to utilize the application 300 as needed by calling the URL to control the device in question or to receive data from the sensor in question. Once downloaded as a sensor pack, the process moves to step 210 as described above.

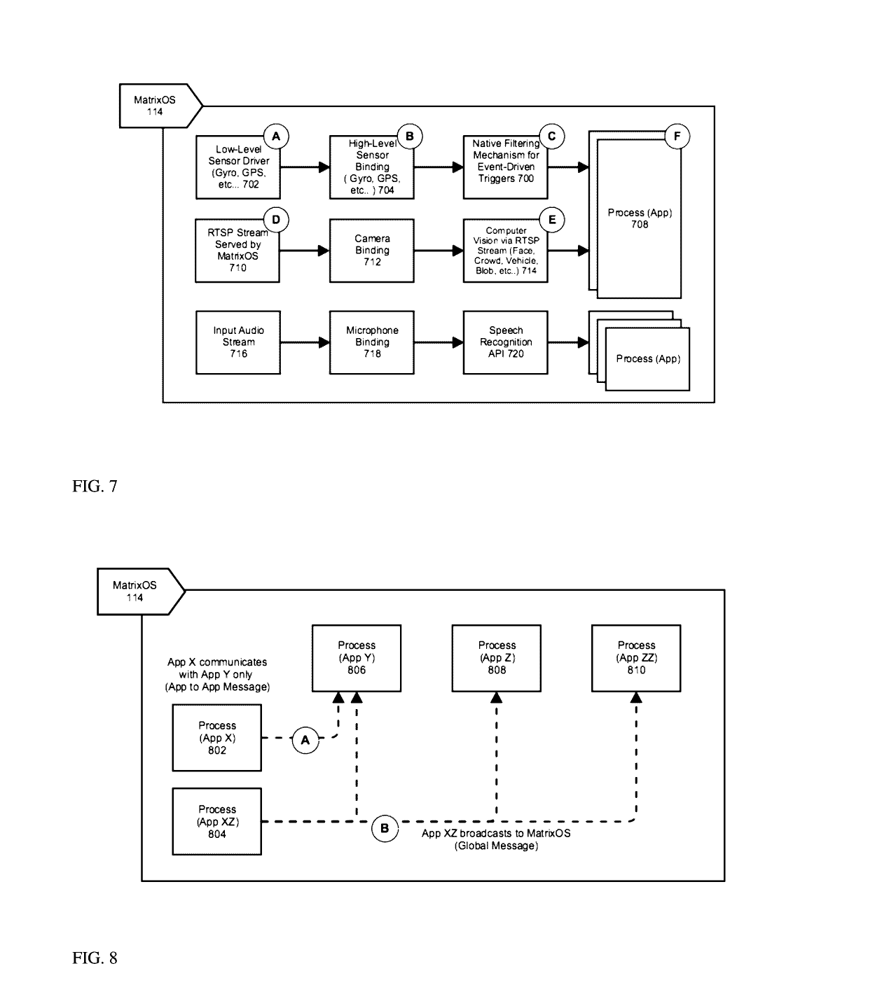

When loading a new device to be operated upon by computing device 102, a discrete sensor reading process, utilizing binding layer 304, initializes on Matrix OS 114 starting with computing device 102, looking for the normalized schema of driver layer 302 in application 300. In this way, application 300 communicates with computing device 102 through Matrix OS 114. By way of a non-limiting example, the data flow from sensor 104 to the application is shown in FIG. 7. When a third party application process is performed, by way of example in step 708, one or more devices may be processed by an individual application 300 or by a number of applications 300 operating in parallel. As seen in FIG. 7, in step 702, Matrix OS 114 recognizes the driver schema of driver layer 302, such as C++ language, for, exemplarily, a sensor interpreter of temperature sensor 104. In step 704, binding layer 304 of the application for the particular sensor (e.g. temperature sensor 104) is processed to determine the type of device. In step 706, the native filtering mechanism of filter layer 306 defines a function of event driven triggers for temperature sensing for processing of a third party application 708. The event triggers are input in a known way to the application, enabling Matrix OS 114 to operate on the data output by temperature sensor 104.

Simultaneously with steps 702-706, Matrix OS 114, utilizing third party application 708 receives an input from a second device, for example from camera 106. Again, the data flow starts with the schema of driver layer schema 302, in this case a RTSP stream recognized by Matrix

OS 114, being operated upon in a step 710. In step 712, Matrix OS 104 uses binding layer 304 uses to recognize that a camera 106 is providing data to be filtered in step 714. In step 714, the output from camera 712 is operated upon by computing device 102 by looking for certain characteristics, as determined by filter layer 306, such as a particular vehicle recognition, face recognition, or the like acting as data output triggers. The filtered data from step 714 is operated upon by application 708.

Matrix OS 114 is capable of operating on different applications in parallel. By way of example, an application 722 operates on audio data. In step 716, an input stream provides control information from driver layer 302 for a microphone. In step 718, the microphone is recognized by Matrix OS 114 from the binder layer information, causing computing device 102 to operate to receive audio data and output the audio data. In step 720, the microphone outputs audio data to be processed by the filter layer of the speech recognition API, which outputs filtered audio data as inputs to a second application 722, which then provides an output to be operated upon by Matrix OS 114 and viewed at dashboard 124 of user device 122. FIG. 8 is an operational diagram of the OS enabling applications to communicate with each other across the system amongst devices in according with an exemplary embodiment disclosed herein. As seen in FIG. 8, the Matrix OS 114 may operate on two or more applications to not only transfer data from one device to another as discussed above, but to enable communication between applications. Matrix OS 114 processes one application 802 to provide inputs only to a second application 806. However, Matrix OS 114 is also capable of enabling a third application 804 to communicate with two or more applications 806, 808 and 810. As can be seen, application 806 processes outputs from both application 802 and application 804. Application 804 broadcasts to Matrix OS 114, enabling it to be utilized by other applications which receive data from devices 104-112 and operate thereon, or provide control output enabling Matrix OS to control a device such as an LED 110 to cause it to flash, or control movement and focusing of a camera 106. This enables users of computing device 102, utilizing Matrix OS 114, to create combinations of applications such as monitoring of motion detector 112 to cause LED 110 to flash in response to motion data as set in filter layer 306 of a motion detector application 300.

Because computing device 102, operating and utilizing the OS of Matrix OS 114, is device and application neutral, it enables two devices to transfer data among themselves even where these devices are not externally accessible.

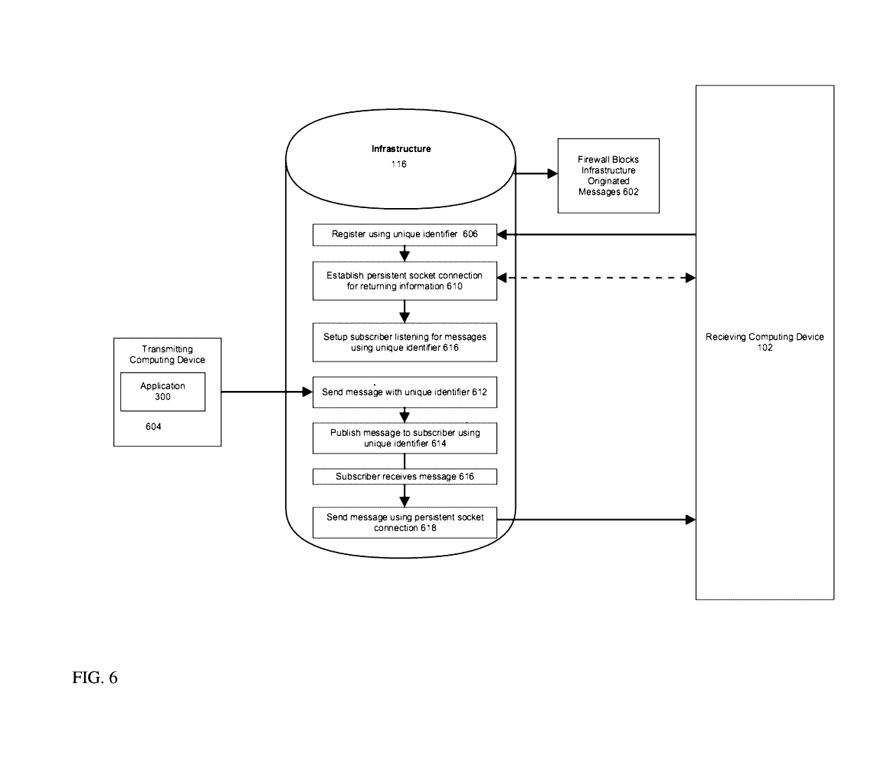

Reference is now made to FIG. 6, which shows an operational diagram for the transfer of data by computing device 102 utilizing Matrix OS 114 to enable two devices to communicate with each other, even when both devices are not externally accessible. By default, a receiving device (computing device 102) blocks messages between devices utilizing firewalls in step 602.

To overcome this, a computing device 102 under the control of Matrix OS 114, acting as a receiving device, registers with cloud infrastructure 116 using a unique identifier in step 606. In step 608, cloud infrastructure 116 creates a subscriber listening for messages having the unique identifier created in step 606. In a step 610, an open persistent socket is created between receiving computing device 102 and cloud infrastructure 116. At substantially the same time, sending device 604, for example a sensor, processing an application 300 residing thereon, sends data with a routing identifier to cloud infrastructure 116 in step 612. Cloud infrastructure 116 causes the data to be published as messages using the identifier in step 614. The subscriber established in step 608 receives the targeted message in a step 616 and, utilizing the socket, sends the data to receiving computing device 102 in step 618.

As a result of the schema for applications as used in connection with system 100, a simple-to-use formatted dashboard 124 may be created and provided at user device 122. Dashboard 124 enables a user to monitor the operation of a sensor or control a remote device communicating with user device 122. Because the schema of the process is substantially known to computer device 102 and user device 122, dashboard 124 is capable of utilizing the expected data and information in a uniform repeatable manner. For example, dashboard 124 may identify the type of data, as from a temperature sensor 104, a video camera 106, a still camera 106, a motion detector 112 or the like. Dashboard 124 may also show the manner in which the data is display, such as a video output, an audio output, a list, a single detected value, a chart, a graph, or the like. Lastly, dashboard 124 will show the manner in which the data is monitored. This corresponds to the filter layer 306 so that data within a certain range, or predetermined intervals corresponding to the filter reporting triggers will be shown. Dashboard 124 is used at user device 122 to create these values to transmit to computing device 102 for controlling functional devices 104-112 utilizing Matrix OS 114 as well as to configure how to monitor outputs from these devices when the devices are sensors. As a result of the data structure, a user can easily determine which data fields to expect and use the data structure to build the dashboard.

It should be understood that where the claims or specification refer to “a” or “an” element, such reference is not to be construed as there being only one of that element.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Unless otherwise stated, the use of the expression “and/or” between the last two members of a list of options for selection indicates that a selection of one or more of the listed options is appropriate and may be made The various features and steps discussed above, as well as other known equivalents for each such feature or step, can be mixed and matched by one of ordinary skill in this art to perform methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof.

Accordingly, the disclosure is not intended to be limited by the specific disclosures of embodiments herein.

What is claimed is:

1. A system for enabling operation of a plurality of functional devices, comprising:
a cloud based infrastructure for storing a plurality of applications for operating at least one of the plurality of functional devices, the applications having a common format, the common format being device and system agnostic;
a first computing device; and
a second computing device in communication with the plurality of functional devices,
wherein the first computing device is configurable to send a command to the cloud based infrastructure to transmit information about a given application to the second computing device, and wherein the second computing device is configurable to receive the information about the given application from the cloud based infrastructure, and to determine, based on the received information, a type of a functional device that can be operated upon with the given application.

2. The system of claim 1, wherein the second computing device is further configurable to determine whether the second computing device can operate the functional device determined to be of a type that can be operated upon with the given application.

3. The system of claim 2, wherein the second computing device is further configurable to operate a functional device determined to be of a type that can be operated upon with the given application.

4. The system of claim 1, wherein the second computing device is controlled by an operating system (OS) and wherein the common application format includes an application format recognized by the OS to be device agnostic.

5. The system of claim 2, wherein the second computing device is controlled by an operating system (OS) and wherein the common application format includes an application format recognized by the OS to be device agnostic.

6. The system of claim 2, wherein the second computing device is controlled by an operating system (OS) and wherein the common application format includes an application format recognized by the OS to be device agnostic.

7. The system of claim 4, wherein the second computing device is configured to communicate with an application through the OS.

8. The system of claim 5, wherein the second computing device is configured to communicate with an application through the OS.

9. The system of claim 6, wherein the second computing device is configured to communicate with an application through the OS.

10. The system of claim 1, wherein a functional device includes an Internet of Things (IoT) device.

11. The system of claim 1, wherein the functional device that can be operated upon with the given application is selected from the group consisting of a temperature sensor, a camera, an environmental controller, an HVAC controller, a light-emitting diode, a motion sensor and a motion detector.

12. The system of claim 1, wherein the second computing device is a portable electronic device.

13. A method for enabling operation of a plurality of functional devices, comprising:
storing in a cloud infrastructure one or more applications for operating functional devices;
formatting all applications stored in the cloud infrastructure in a common format, the common format being device and system agnostic;
transmitting information identifying at least one of the stored applications to a computing device that operates at least one functional device using applications; and
determining, as a function of the format of the transmitted at least one application, the type of functional device to be operated utilizing the transmitted at least one application and determining whether the computing device can operate the determined device to be operated utilizing the transmitted at least one application.

14. A computing device having computer readable instructions stored thereon, the computer readable instructions defining an operating system executable by the computing device, the computer executable instructions, when executed cause the computing device to perform:
storing in a cloud infrastructure one or more applications for operating functional devices;
formatting all applications stored in the cloud infrastructure in a common format, the common format being device and system agnostic;
transmitting information identifying at least one of the stored applications to a computing device that operates at least one functional device using applications; and
determining, as a function of the format of the transmitted at least one application, the type of functional device to be operated utilizing the transmitted at least one application and determining whether the computing device can operate the determined device to be operated utilizing the transmitted at least one application.
